(19) United States
(12) Patent Application Publication
(10) Pub. No.: US 2010/0321751 A1
(43) Pub. Date: Dec. 23, 2010

(54) MIRROR ACTUATOR AND BEAM IRRADIATION DEVICE

(75) Inventors: Masato Yamada, Inuyama-City (JP); Yoichiro Goto, Gifu-City (JP); Nobuo Iwatsuki, Anpachi-Gun (JP); Yoshiaki Maeno, Mizuho-City (JP)

Correspondence Address: DITTHAVONG MORI & STEINER, P.C., 918 Prince Street, Alexandria, VA, 22314, US

(73) Assignee: SANYO Electric Co., Ltd., Moriguchi-shi (JP)

(21) Appl. No.: 12/815,788

(22) Filed: Jun. 15, 2010

(30) Foreign Application Priority Data
Jun. 19, 2009 (JP) 2009-145955

(51) Int. Cl. G02B 26/10; G02B 7/182

(52) U.S. Cl. 359/200.7; 359/225.1

(57) ABSTRACT

A mirror actuator includes a base block; a first pivot shaft fixedly attached to the base block; a first pivot portion pivotally supported on the first pivot shaft; a second pivot shaft fixedly attached to the first pivot portion and perpendicularly intersecting with the first pivot shaft; a second pivot portion pivotally supported on the second pivot shaft; and a mirror attached to the second pivot portion. In the above arrangement, the first pivot portion and the second pivot portion respectively have a first bearing portion and a second bearing portion for bearing the first pivot shaft and the second pivot shaft at one position.

This application claims priority under 35 U.S.C. Section 119 of Japanese Patent Application No. 2009-145955 filed Jun. 19, 2009, entitled “MIRROR ACTUATOR AND BEAM IRRADIATION DEVICE”. The disclosure of the above application is incorporated herein by reference.

### BACKGROUND OF THE INVENTION

1. Field of the Invention

The present invention relates to a mirror actuator for pivotally moving a mirror about two axes as pivot axes, and a beam irradiation device loaded with the mirror actuator.

2. Disclosure of Related Art

In recent years, a laser radar system has been loaded in a family automobile or a like vehicle to enhance security in driving. Generally, the laser radar system is so configured as to scan a targeted area with laser light to detect presence or absence of an obstacle at each of scanning positions, based on presence or absence of reflected light at each of the scanning positions. The laser radar system is also configured to detect a distance to the obstacle, based on a required time from an irradiation timing of laser light to a light receiving timing of reflected light at each of the scanning positions.

As a mirror actuator for scanning a targeted area with laser light, for instance, a mirror actuator for pivotally moving a mirror about two axes as pivot axes may be used. In the case where the mirror actuator is used, laser light is entered into the mirror in an oblique direction. In response to pivotal movement of the mirror about two axes as pivot axes in a horizontal direction and a vertical direction, laser light swings in the horizontal direction and the vertical direction within the targeted area.

In the mirror actuator, it is desirable to enhance the performance of pivotally moving the mirror by maximally suppressing friction or an unwanted braking force with respect to each of the pivot axes.

### SUMMARY OF THE INVENTION

A first aspect of the invention is directed to a mirror actuator. The mirror actuator according to the first aspect includes a base block; a first pivot shaft fixedly attached to the base block; a first pivot portion pivotally supported on the first pivot shaft; a second pivot shaft fixedly attached to the first pivot portion and perpendicularly intersecting with the first pivot shaft; a second pivot portion pivotally supported on the second pivot shaft; and a mirror attached to the second pivot portion. In the above arrangement, the first pivot portion and the second pivot portion respectively have a first bearing portion and a second bearing portion forbearing the first pivot shaft and the second pivot shaft at one position.

A second aspect of the invention is directed to a beam irradiation device. The beam irradiation device according to the second aspect includes the mirror actuator according to the first aspect, and a laser light source for supplying laser light to the mirror of the mirror actuator.

### BRIEF DESCRIPTION OF THE DRAWINGS

These and other objects, and novel features of the present invention will become more apparent upon reading the following detailed description of the embodiment along with the accompanying drawings.

FIG. 1 is an exploded perspective view of a mirror actuator according to an embodiment of the present invention.

FIGS. 2A and 2B are diagrams showing assembled states of the mirror actuator of the embodiment.

FIGS. 3A and 3B are diagrams showing arrangements of magnets as an embodiment and a modification.

FIG. 4 is a diagram showing an optical system of a beam irradiation device embodying the invention.

FIGS. 5A and 5B are diagrams showing an optical system of the beam irradiation device of the embodiment.

FIG. 6 is a diagram showing a circuit configuration of a laser radar system embodying the invention.

FIGS. 7A and 7B are diagrams for describing an advantage of the embodiment.

The drawings are provided mainly for describing the present invention, and do not limit the scope of the present invention.

### DESCRIPTION OF PREFERRED EMBODIMENTS

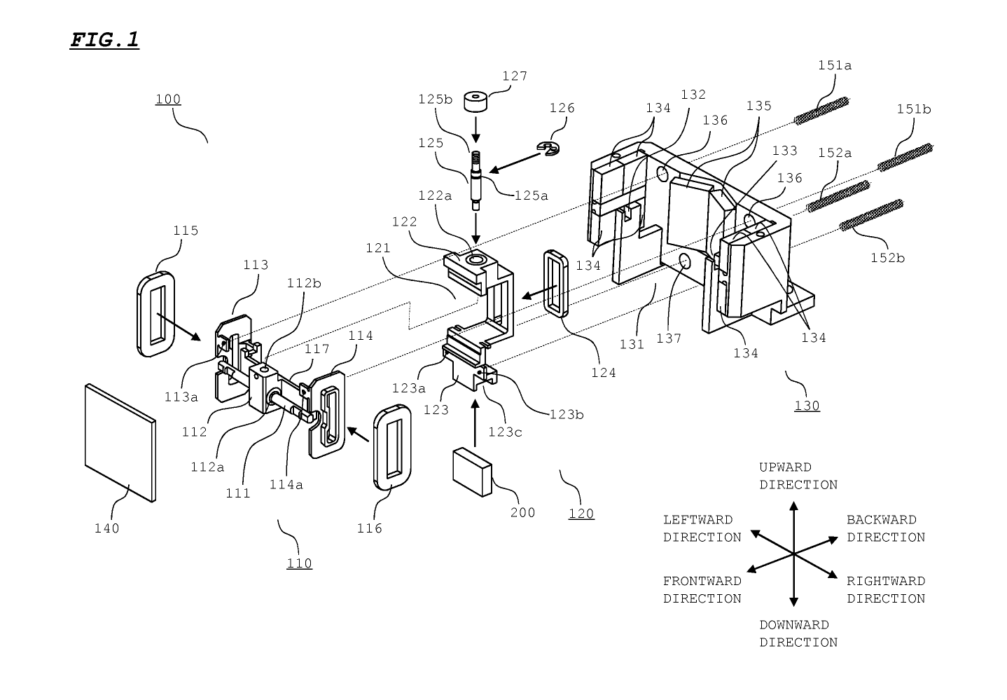

FIG. 1 is an exploded perspective view of a mirror actuator 100 embodying the invention.

Referring to FIG. 1, the reference numeral 110 indicates a tilt unit. The tilt unit 110 includes a support shaft 111, a bearing portion 112 pivotally mounted on the support shaft 111, coil support plates 113 and 114 disposed symmetrical to each other with respect to the bearing portion 112, coils 115 and 116 to be attached to the coil support plates 113 and 114 respectively, and a linking portion 117 for linking the bearing portion 112 to the coil support plates 113 and 114.

The bearing portion 112 is formed with a through-shaft hole 112a extending in left and right directions. The support shaft 111 passes through the shaft hole 112a. The bearing portion 112 is mounted on a middle portion of the support shaft 111. A hole 112b is formed in a top surface of the bearing portion 112.

Flange portions projecting in left and right directions are respectively formed on upper side surfaces of the coil support plates 113 and 114. Engaging holes 113a and 114a are respectively formed in the flange portions. The engaging holes 113a and 114a are formed at positions symmetrical to each other with respect to the bearing portion 112. The positions of the engaging holes 113a and 114a are identical to each other with respect to up and down directions and front and back directions.

The coils 115 and 116 wound into a rectangular shape are respectively attached to the coil support plates 113 and 114. An output end of the coil 115 is connected to an input end of the coil 116 through a signal line (not shown).

The reference numeral 120 indicates a pan unit. The pan unit 120 includes a recess portion 121 for accommodating the tilt unit 110, a bearing portion 122 formed in connection to an upper portion of the recess portion 121, a receiving portion 123 formed in connection to a lower portion of the recess portion 121, a coil 124 to be attached to a back surface of the recess portion 121, a support shaft 125, an E-ring 126, and a balancer 127.

The bearing portion 122 is formed with a through-shaft hole 122a extending in up and down directions. As will be described later, the support shaft 125 passes through the shaft hole 122a in up and down directions in assembling the tilt unit 110 and the pan unit 120. As shown in FIG. 1, a groove 125a to be engaged with the E-ring 126 is formed in the support shaft 125. A screw groove 125b for mounting the balancer 127 is formed in an upper portion of the support shaft 125.

The receiving portion 123 is formed with engaging holes 123a and 123b. The engaging holes 123a and 123b are formed at positions symmetrical to each other with respect to the support shaft 125. The positions of the engaging holes 123a and 123b are identical to each other with respect to up and down directions and front and back directions. A recess portion 123c is formed in a lower end of the receiving portion 123. The gap of the recess portion 123c in front and back directions is set substantially equal to the thickness of a transparent member 200. An upper portion of the transparent member 200 is mounted in the recess portion 123c.

A coil attaching portion (not shown) is formed in a back surface of the pan unit 120. The coil 124 wound into a rectangular shape is attached to the coil attaching portion.

The reference numeral 130 indicates a magnet unit. The magnet unit 130 includes a recess portion 131 for accommodating the pan unit 120, grooves 132 and 133 to be engaged with both ends of the support shaft 111 respectively, eight magnets 134 for applying a magnetic field to the coils 115 and 116, and two magnets 135 for applying a magnetic field to the coil 124.

The eight magnets 134 are attached to upper and lower portions on left and right inner surfaces of the recess portion 131. As shown in FIG. 1, the two magnets 135 are attached to an inner surface of the recess portion 131 with an inward inclination with respect to front and back directions. The recess portion 131 is formed with holes 136 and 137 into which power supply springs 151a, 151b, 152b, and 152b are received.

Next, a sequence of assembling the parts into the mirror actuator 100 is described.

In assembling the parts into the mirror actuator 100, first, the tilt unit 110 is assembled. Specifically, the support shaft 111 is mounted in the shaft hole 112a, and the coils 115 and 116 are attached to the coil support plates 113 and 114.

Thereafter, the assembled tilt unit 110 is received in the recess portion 121 of the pan unit 120. Then, the support shaft 125 is received from above in a state that the hole 112b of the tilt unit 110 is aligned with the shaft hole 122a of the pan unit 120 in up and down directions. A lower end of the support shaft 125 is fixedly mounted in the hole 112b. Thereafter, the E-ring 126 is engaged with the groove 125a. As a result of performing the above operation, the support shaft 125 is kept from moving downwardly with respect to the pan unit 120 from the position where the E-ring 126 is engaged. Thus, the pan unit 120 is pivotally supported by the support shaft 125 with respect to the tilt unit 110.

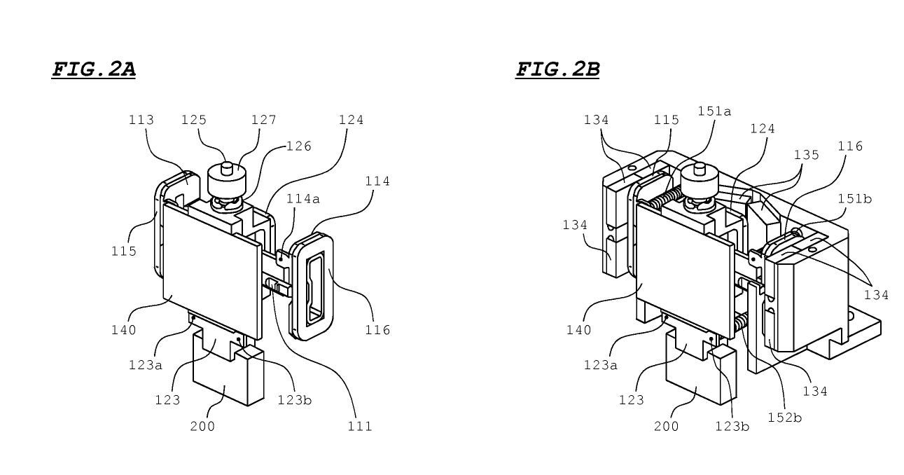

Thereafter, the balancer 127 is engaged with the screw groove 125b of the support shaft 125. Further, the transparent member 200 is mounted in the recess portion 123c. Further, a mirror 140 is attached to a front surface of the pan unit 120. Thus, as shown in FIG. 2A, the assembling operation of the tilt unit 110, the pan unit 120, and the mirror 140 is completed.

The balancer 127 is adapted to perform pivotal movement of the mirror actuator 100 in a well-balanced manner when the constituent components of the mirror actuator 100 which pivotally moves around the support shaft 111 are pivotally moved about an axis of the support shaft 111. The pivotal balance is secured by the weight of the balancer 127. Alternatively, the pivotal balance may be secured by finely adjusting the position of the balancer 127 in up and down directions by the screw groove 125b of the support shaft 125.

Thereafter, the structural body shown in FIG. 2A is attached to the magnet unit 130.

Referring back to FIG. 1, first, both ends of the support shaft 111 are fixedly mounted in the grooves 132 and 133 of the magnet unit 130 from above. Engaging portions to be engaged in the grooves 132 and 133 are formed on both ends of the support shafts 111. Fitting the engaging portions in the grooves 132 and 133 enables to fixedly mount the support shaft 111 in the grooves 132 and 133 without pivotal movement of the support shaft 111.

Subsequently, the power supply springs 151a, 151b, 152a, and 152b are received in the holes 136 and 137 from the back surface side of the recess portion 131. In performing the above operation, lead ends of the power supply springs 151a and 151b are respectively engaged in the engaging holes 113a and 114a of the tilt unit 110. Further, the lead ends of the engaged power supply springs 151a and 151b are respectively and electrically connected to an input end of the coil 115 and an output end of the coil 116 by soldering or a like process. Rear ends of the power supply springs 151a and 151b are engaged in engaging holes formed in a back surface of the magnet unit 130.

Further, lead ends of the power supply springs 152a and 152b are respectively engaged in the engaging holes 123a and 123b of the pan unit 120. Further, the lead ends of the engaged power supply springs 152a and 152b are respectively and electrically connected to an input end and an output end of the coil 124 by soldering or a like process. Rear ends of the power supply springs 152a and 152b are engaged in engaging holes formed on the back surface of the magnet unit 130.

In the case where a relay substrate is attached to the back surface of the magnet unit 130, the rear ends of the power supply springs 151a, 151b, 152a, and 152b are engaged in engaging holes formed in the relay substrate.

An exemplified material of the power supply springs 151a, 151b, 152a, and 152b is beryllium copper having a small resistance value and high durability. In this embodiment, a coil spring formed by winding a wire material having a high conductivity into a coil shape is used as the power supply springs 151a, 151b, 152a, and 152b.

Thus, the assembling operation of the mirror actuator 100 is completed as shown in FIG. 2B. By disposing the assembled mirror actuator 100 in such a position that up and down directions shown in FIG. 1 are aligned in parallel to the vertical direction, the support shaft 111 and the support shaft 125 are respectively set in parallel to left and right directions and up and down directions shown in FIG. 1, whereby the mirror 140 faces in the forward direction.

The lengths, the spring constants, and a like parameter of the power supply springs 151a, 151b, 152a, and 152b are set to such values that the mirror 140 of the mirror actuator 100 faces in the forward direction after the mirror actuator 100 has been assembled. Further, the power supply springs 151a, 151b, 152a, and 152b are so configured as to have expandability and contractibility in an allowable pivot range of the mirror 140 after the mirror actuator 100 has been assembled.

Referring to FIGS. 1, 2A, and 2B, when the pan unit 120 is pivotally moved about an axis of the support shaft 125 with respect to the tilt unit 110, the mirror 140 is pivotally moved in accordance with the pivotal movement of the pan unit 120. Further, when the tilt unit 110 is pivotally moved about the axis of the support shaft 111 with respect to the magnet unit 130, the pan unit 120 is pivotally moved in accordance with the pivotal movement of the tilt unit 110, whereby the mirror 140 is pivotally moved with the pan unit 120. Thus, the mirror 140 is pivotally supported by the support shafts 111 and 125 perpendicularly intersecting with each other, and the mirror 140 is pivotally moved around the support shafts 111 and 125 by energization of the coils 115, 116, and 124. In performing the above operation, the transparent member 200 attached to the pan unit 120 is also pivotally moved in accordance with the pivotal movement of the mirror 140.

The disposition and the polarities of the eight magnets 134 are adjusted in the assembled state shown in FIG. 2B in such a manner that a force for pivotally moving the tilt unit 110 about the axis of the support shaft 111 is generated by applying a current to the coils 115 and 116 through the power supply springs 151a and 151b. Accordingly, in response to application of a current to the coils 115 and 116, the tilt unit 110 is pivotally moved about the axis of the support shaft 111 by an electromagnetic driving force generated in the coils 115 and 116.

Further, the disposition and the polarities of the two magnets 135 are adjusted in the assembled state shown in FIG. 2B in such a manner that a force for pivotally moving the pan unit 120 about the axis of the support shaft 125 is generated by applying a current to the coil 124. Accordingly, in response to application of a current to the coil 124, the pan unit 120 is pivotally moved about the axis of the support shaft 125 by an electromagnetic driving force generated in the coil 124, and the transparent member 200 is pivotally moved in accordance with the pivotal movement of the pan unit 120.

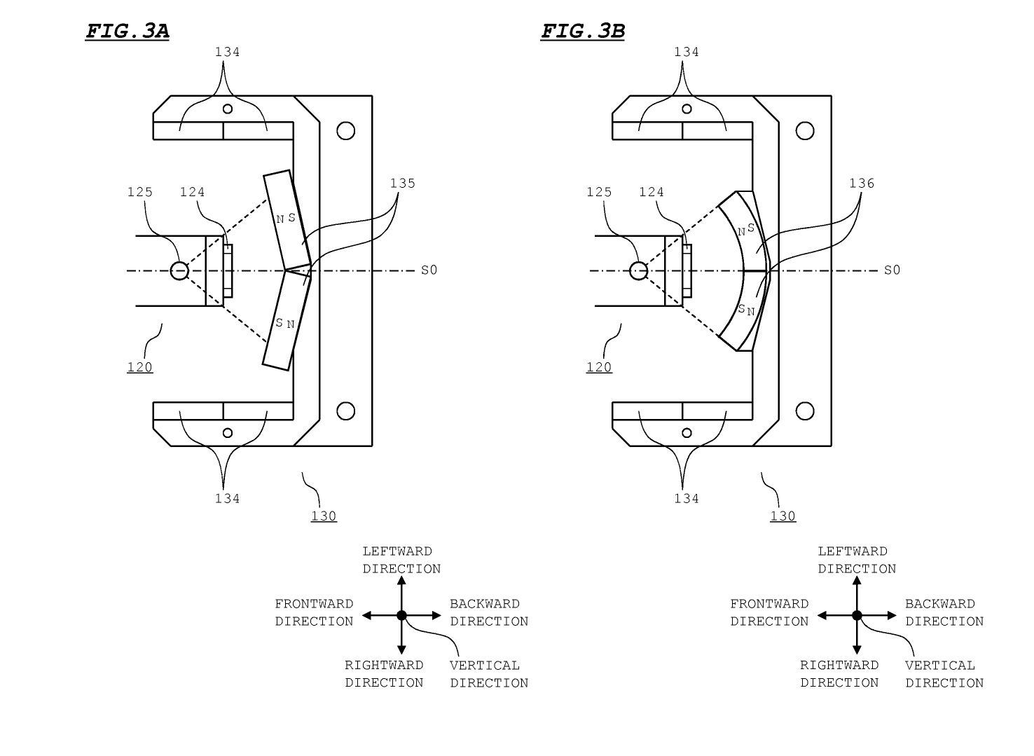

FIG. 3A is a partially plan view of the assembled mirror actuator 100, when viewed from above. As shown in FIG. 3A, the two magnets 135 are disposed with such an inclination that the two magnets 135 are symmetrical to each other with respect to a plane SO passing the support shaft 125 and perpendicular to left and right directions. Further, as shown in FIG. 3A, the two magnets 135 are disposed at such positions that surfaces of the two magnets 135 facing the coil 124 respectively have a north pole and a south pole.

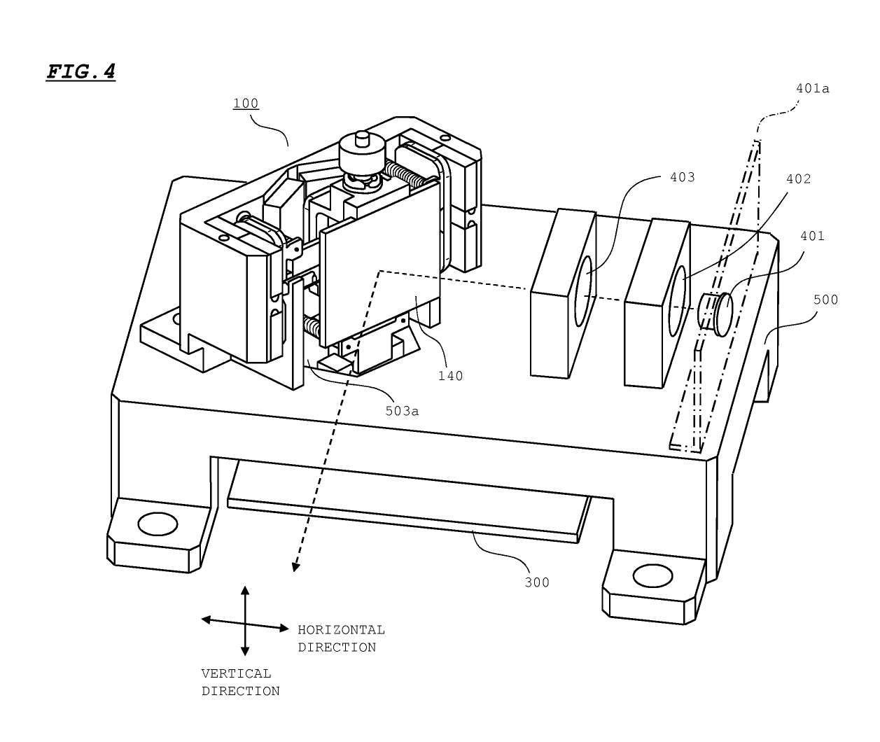

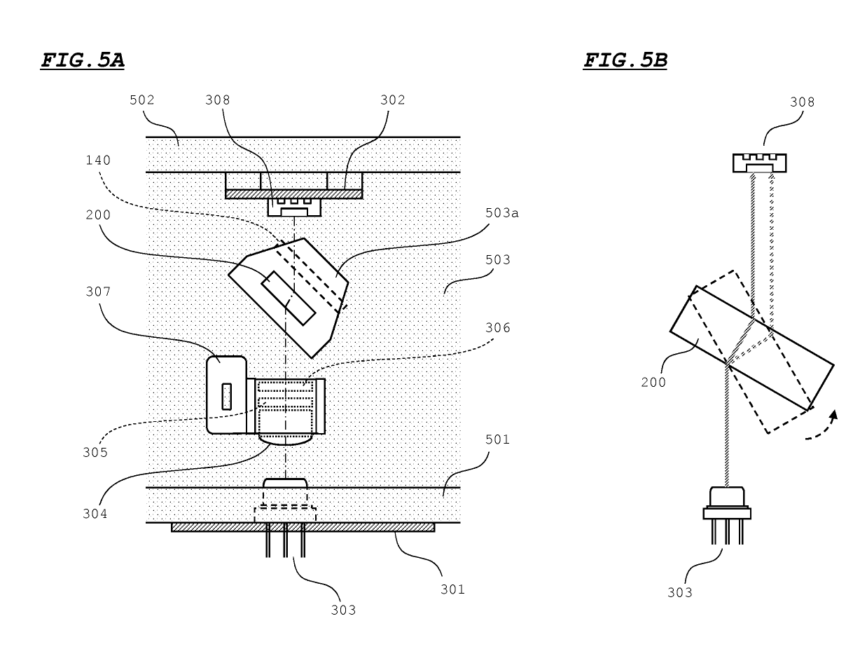

Next, an optical system of a beam irradiation device is described referring to FIGS. 4, 5A, and 5B.

First, referring to FIG. 4, a scanning optical system is described. In FIG. 4, the reference numeral 500 indicates a base block. In FIG. 4, a top surface of the base block 500 horizontally extends. The base block 500 is formed with an opening 503a at a position where the mirror actuator 100 is installed. The mirror actuator 100 is mounted on the base block 500 in a state that the transparent member 200 is received in the opening 503a. The mirror actuator 100 is mounted on the base block 500, with up and down directions shown in FIG. 1 being aligned with the vertical direction shown in FIG. 4.

A laser light source 401, and lenses 402 and 403 for beam shaping are disposed on the top surface of the base block 500. The laser light source 401 is attached to a substrate 401a for a laser light source, which is disposed on the top surface of the base block 500.

Laser light (hereinafter, called as “scanning laser light”) emitted from the laser light source 401 is subjected to convergence in a horizontal direction and a vertical direction by the lenses 402 and 403, respectively. The lenses 402 and 403 are designed in such a manner that the beam shape in a targeted area (e.g. an area defined at a position away in a forward direction from a beam exit port of a beam irradiation device by about 100 m) has predetermined dimensions (e.g. dimensions of about 2 m in the vertical direction and 1 m in the horizontal direction).

The lens 402 is a cylindrical lens having a lens function in the vertical direction, and the lens 403 is an aspherical lens for emitting scanning laser light as substantially parallel light. A beam emitted from a laser light source has different divergence angles from each other in the vertical direction and the horizontal direction. The first lens 402 changes a ratio between divergence angles of laser light in the vertical direction and the horizontal direction. The second lens 403 changes magnifications (both in the vertical direction and the horizontal direction) of divergence angles of an emitted beam.

Scanning laser light transmitted through the lenses 402 and 403 is entered into the mirror 140 of the mirror actuator 100, and reflected on the mirror 140 toward a targeted area. The targeted area is scanned with the scanning laser light when the mirror 140 is driven by the mirror actuator 100 about two axes.

The mirror actuator 100 is disposed at such a position that scanning laser light from the lens 403 is entered into a mirror surface of the mirror 140 with an incident angle of 45 degrees with respect to the horizontal direction, when the mirror 140 is set to a neutral position. The term “neutral position” indicates a position of the mirror 140, wherein the mirror surface is aligned in parallel to the vertical direction, and scanning laser light is entered into the mirror surface with an incident angle of 45 degrees with respect to the horizontal direction. The mirror 140 is positioned to the neutral position in a state that the coils 115, 116, and 124 are de-energized.

A circuit board 300 is provided underneath the base block 500. Further, circuit boards 301 and 302 are provided on a back surface and a side surface of the base block 500.

FIG. 5A is a partially plan view of the base block 500, when viewed from the back surface side. FIG. 5A shows an arrangement of a servo optical system and peripheral parts thereof disposed on the back surface of the base block 500.

As shown in FIG. 5A, walls 501 and 502 are formed along the perimeter of the back surface of the base block 500. A flat surface 503 lower than the walls 501 and 502 is formed in a middle portion of the back surface of the base block 500 with respect to the walls 501 and 502. The wall 501 is formed with an opening for receiving a semiconductor laser 303. The circuit board 301 loaded with the semiconductor laser 303 is attached to an outer side surface of the wall 501 in such a manner that the semiconductor laser 303 is received in the opening of the wall 501. Further, the circuit board 302 loaded with a PSD 308 is attached to a position near the wall 502.

A light collecting lens 304, an aperture 305, and a ND (neutral density) filter 306 are mounted on the flat surface 503 on the back surface of the base block 500 by an attachment member 307. The flat surface 503 is formed with the opening 503a, and the transparent member 200 attached to the mirror actuator 100 is projected from the back surface of the base block 500 through the opening 503a. In this example, when the mirror 140 of the mirror actuator 100 is set to the neutral position, the transparent member 200 is set to such a position that the two flat surfaces of the transparent member 200 are aligned in parallel to the vertical direction, and are inclined with respect to an optical axis of emission light from the semiconductor laser 303 by 45 degrees.

Laser light (hereinafter, called as “servo light”) emitted from the semiconductor laser 303 is transmitted through the light collecting lens 304, has the beam diameter thereof reduced by the aperture 305, and has the light intensity thereof reduced by the ND filter 306. Thereafter, the servo light is entered into the transparent member 200, and subjected to refraction by the transparent member 200. Thereafter, the servo light transmitted through the transparent member 200 is received by the PSD 308, which, in turn, outputs a position detection signal depending on a light receiving position of servo light.

FIG. 5B is a diagram schematically showing how a pivotal position of the transparent member 200 is detected by the PSD 308. In FIG. 5B, to simplify the description, only the transparent member 200, the semiconductor laser 303, and the PSD 308 in FIG. 5A are shown.

Servo light is refracted by the transparent member 200 disposed with an inclination with respect to an optical axis of laser light, and received by the PSD 308. In this example, in the case where the transparent member 200 is pivotally moved from the broken-line position in the direction of broken-line arrow in FIG. 5B, the optical path of servo light is changed from the dotted-line state to the solid-line state shown in FIG. 5B, with the result that the light receiving position of servo light on the PSD 308 is changed. Thus, the pivotal position of the transparent member 200 can be detected by the light receiving position of servo light to be detected by the PSD 308. A pivotal position of the transparent member 200 corresponds to a scanning position of scanning laser light in a targeted area. Accordingly, it is possible to detect a scanning position of scanning laser light in a targeted area, based on a signal from the PSD 308.

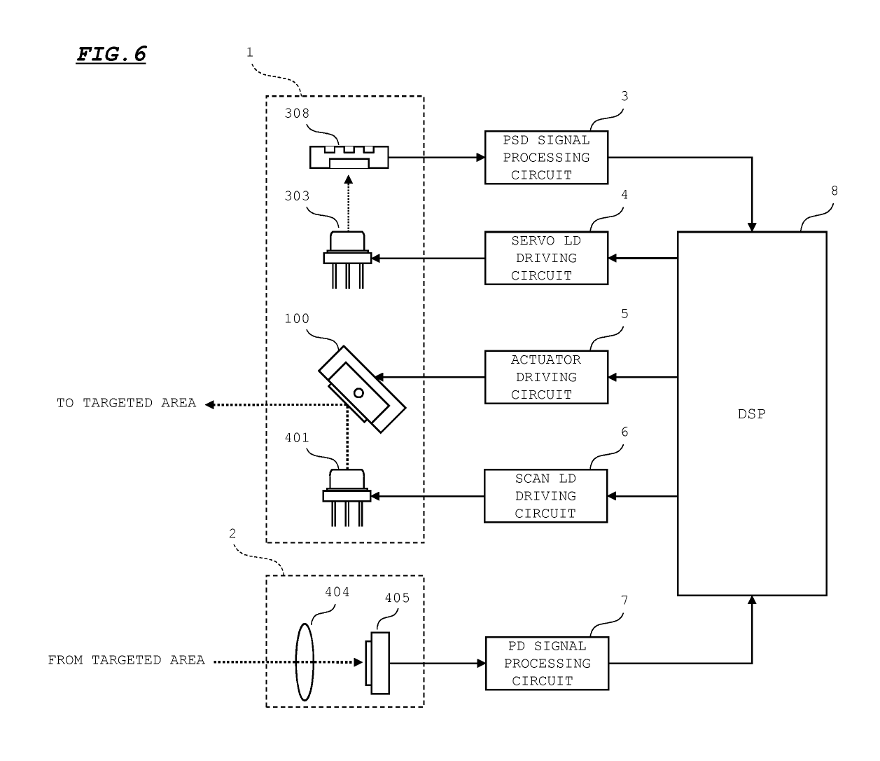

FIG. 6 is a diagram showing an arrangement of a laser radar system. As shown in FIG. 6, the laser radar system includes a scanning section 1, a light receiving section 2, a PSD signal processing circuit 3, a servo LD driving circuit 4, an actuator driving circuit 5, a scan LD driving circuit 6, a PD signal processing circuit 7, and a DSP 8.

The scanning section 1 has the scanning optical system shown in FIG. 4, and the servo optical system shown in FIG. 5A. In FIG. 6, to simplify the description, only the laser light source 401, the mirror actuator 100, the semiconductor laser 303, and the PSD 308 are illustrated as parts of the scanning section 1. The light receiving section 2 has a light collecting lens 404 for collecting scanning laser light reflected on a targeted area, and a PD (Photo Detector) 405 for receiving the scanning laser light collected by the light collecting lens 404.

The PSD signal processing circuit 3 generates a position detection signal based on an output signal from the PSD 308, and outputs the position detection signal to the DSP 8.

The servo LD driving circuit 4 supplies a drive signal to the semiconductor laser 303, based on a signal from the DSP 8. Specifically, servo light of a constant output is outputted from the semiconductor laser 303 at a time of operating the scanning section 1.

The actuator driving circuit 5 drives the mirror actuator 100, based on a signal from the DSP 8. Specifically, a drive signal for driving scanning laser light along a predetermined trajectory in a targeted area is supplied from the mirror actuator 100.

The scan LD driving circuit 6 supplies a drive signal to the laser light source 401, based on a signal from the DSP 8. Specifically, pulse light is emitted from the semiconductor laser 303 at a timing when a scanning position of scanning laser light matches with a predetermined position in a targeted area.

The PD signal processing circuit 7 amplifies and digitizes a signal from the PD 405, and supplies the signal to the DSP 8.

The DSP 8 detects a scanning position of scanning laser light in a targeted area, based on a position detection signal inputted from the PSD signal processing circuit 3, and performs e.g. a drive-control of the mirror actuator 100, and a drive-control of the laser light source 401. Further, the DSP 8 determines whether or not there is an obstacle at an irradiation position of scanning laser light in a targeted area, based on an signal to be inputted from the PD processing circuit 7, and measures a distance to the obstacle, based on a time difference between an irradiation timing of scanning laser light to be outputted from the laser light source 401, and a light receiving timing of reflected light from a targeted area, which is detected by the PD 405.

As described above, in the embodiment, it is possible to suppress friction or an unwanted braking force with respect to the support shaft 111 and the support shaft 125 to thereby realize the mirror actuator 100 having enhanced performance of pivotally moving the mirror 140.

Specifically, the embodiment is configured in such a manner that the support shaft 111 is fixedly attached to the magnet unit 130, and the bearing portion 112 is pivotally moved with respect to the support shaft 111. Further, the bearing portion 112 is constructed to bear the support shaft 111 only at a middle portion thereof. In this arrangement, since friction is caused only at the middle portion of the support shaft 111, it is possible to suppress an influence by friction at the time pivotally moving the mirror 140 about the axis of the support shaft 111.

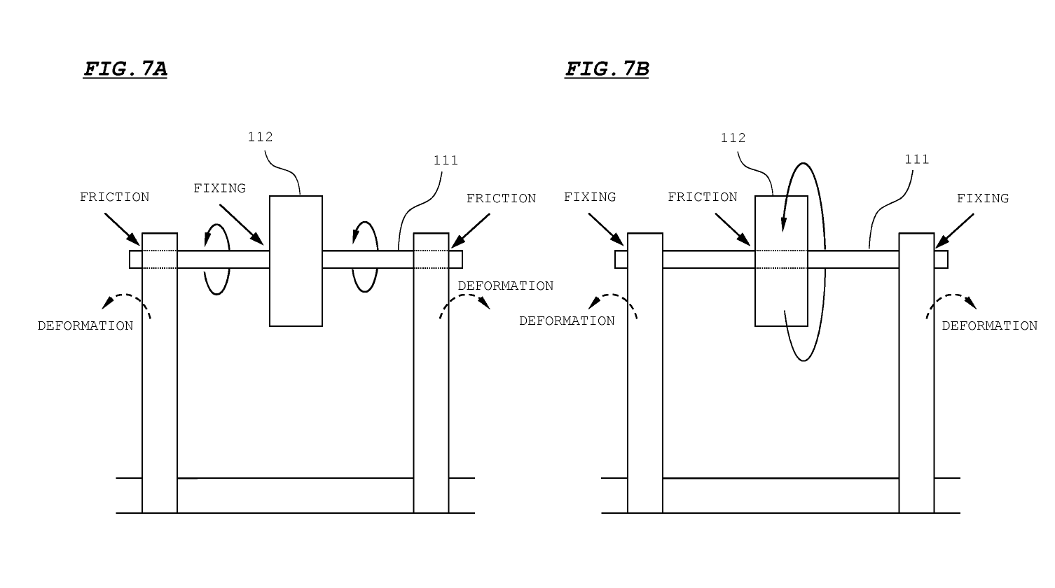

For instance, as shown in FIG. 7A, in the arrangement, wherein a support shaft 111 itself is pivotally moved, and both ends of the support shaft 111 are pivotally borne by a bearing portion, friction is caused at two positions i.e. both ends of the support shaft 111. In this case, a friction force exerted on the support shaft 111 is relatively large. In contrast, in this embodiment, as shown in FIG. 7B, since friction is caused only at one position i.e. the middle portion of the support shaft 111, an influence by friction at the time of pivotally moving the mirror 140 about the axis of the support shaft 111 can be advantageously suppressed, as compared with the arrangement shown in FIG. 7A.

Further, in the arrangement shown in FIG. 7A, if a support portion for supporting the support shaft 111 is deformed by heat or a like factor, as shown by the broken-line arrow in FIG. 7A, a force for braking pivotal movement of the support shaft 111 is exerted on both ends of the support shaft 111 by the deformation. As a result, pivotal movement of the mirror 140 about the axis of the support shaft 111 becomes unstable. In contrast, in this embodiment, since the support shaft 111 is fixedly attached to a support portion, there is no likelihood that pivotal movement of the mirror 140 may be obstructed by deformation of the support portion, even if the support portion is deformed.

In the foregoing section, the function and the advantage of the support shaft 111 have been described. The support shaft 125 has substantially the same function and advantage as described above. Specifically, similarly to the support shaft 111, the support shaft 125 is also borne at one position. Accordingly, it is possible to effectively suppress friction or an unwanted braking force.

As described above, the embodiment is advantageous in suppressing friction or an unwanted braking force with respect to the support shaft 111 and the support shaft 125 to thereby enhance the performance of pivotally moving the mirror 140.

Further, in the embodiment, since power supply to the coils 115, 116, and 124 is performed by the power supply springs 151a, 151b, 152a, and 152b, power supply to the coils 115, 116, and 124 can be stably and securely performed. In the case where the mirror actuator 100 is loaded in a laser radar system, as described in the embodiment, the tilt unit 110 and the pan unit 120 are oscillated with a relatively short cycle. In this case, if a drawing wire is used for power supply, the drawing wire may be deteriorated or disconnected by the oscillations. In contrast, in the embodiment, the power supply springs 151a, 151b, 152a, and 152b are less likely to cause deterioration or disconnection, even if the tilt unit 110 and the pan unit 120 are oscillated with a high frequency. Accordingly, the embodiment is advantageous in stably and securely performing power supply to the tilt unit 110 and the pan unit 120, thereby enhancing reliability of the mirror actuator 100.

Further, in this embodiment, the two magnets 135 are disposed with an inward inclination with respect to front and back directions, as shown in FIGS. 1 and 3A. Accordingly, even if the tilt unit 120 is pivotally moved about the axis of the support shaft 125, a variation in the distance between the magnets 135 and the coil 124 is suppressed, and it is possible to apply a substantially constant magnetic field to the coil 124. Accordingly, it is easy to control pivotal movement of the mirror 140 about the axis of the support shaft 125.

Furthermore, in this embodiment, since the balancer 127 is provided, pivotal movement of the mirror 140 about the axis of the support shaft 111 can be stably performed.

In the foregoing, an embodiment of the invention has been described. The invention is not limited to the foregoing embodiment, and the embodiment of the invention may be modified in various ways other than the above.

For instance, in the embodiment, a semiconductor laser is used as a light source for servo light. Alternatively, an LED (Light Emitting Diode) may be used in place of the semiconductor laser.

Further, in the embodiment, the balancer 127 is disposed at an upper end of the support shaft 125. Alternatively, as far as the balancer 127 is disposed at a position capable of securing pivotal balance about the axis of the support shaft 111, the balancer 127 maybe disposed at any position other than the above.

Furthermore, in the embodiment, the magnets 135 are provided with an inward inclination with respect to front and back directions, as shown in FIGS. 1 and 3A. Alternatively, two arc-shaped magnets may be provided.

FIG. 3B shows an arrangement example, wherein two arc-shaped magnets 136 are used. Similarly to FIG. 3A, FIG. 3B is a partially plan view of the mirror actuator 100 when viewed from above. The magnets 136 have a linear shape in up and down directions.

As shown in FIG. 3B, the two magnets 136 are disposed at such positions that surfaces of the two magnets 136 facing the coil 124 have a north pole and a south pole, respectively. The surfaces of the two magnets 136 facing the coil 124 have an arc shape with respect to the support shaft 125 as a center. Specifically, the surfaces of the two magnets 136 facing the coil 124 are formed into an arc shape. Further, the two magnets 136 are disposed at such positions that the two magnets 136 are symmetrical to each other with respect to a plane S0 passing the support shaft 125 and perpendicular to left and right directions. This arrangement enables to easily make an electromagnetic driving force substantially constant, because the magnetic field to be applied to the coil 124 by the magnets 136 becomes substantially constant, even if the pan unit 120 is pivotally moved about the axis of the support shaft 125.

The magnets 136 have a linear shape in up and down directions. Alternatively, the magnets 136 may have an arc shape in up and down directions, in addition to left and right directions. The modification enables to suppress a variation in the magnetic field to be applied from the magnets 136 to the coil 124, even if the mirror 140 is pivotally moved about the axis of the support shaft 111.

In the embodiment, the coils 115 and 116 in the tilt unit 110 are disposed perpendicular to the support shaft 111. Alternatively, the coils 115 and 116 may be disposed in parallel to the support shaft 111. In the modification, it is necessary to change the construction and the disposition of the magnets 134 depending on the positions of the coils 115 and 116.

Further, in the embodiment, the coil 124 in the pan unit 120 is disposed in parallel to the support shaft 125. Alternatively, the coil 124 may be disposed perpendicular to the support shaft 125. Similarly to the above modification, in the modification, it is also necessary to change the construction and the disposition of the magnets 135 depending on the position of the coil 124.

Furthermore, in the embodiment, a coil is disposed on the side of a pivot portion, and a magnet is disposed on the side of a fixed portion. Alternatively, a coil may be disposed on the side of a fixed portion, and a magnet may be disposed on the side of a pivot portion.

Furthermore, in the embodiment, the propagating direction of servo light is changed by using the transparent member 200. Alternatively, a servo mirror may be attached to a lower end of the pan unit 120, in place of the transparent member, and the propagating direction of servo light may be changed by reflecting the servo light on the servo mirror. Further alternatively, it is possible to provide a light source for emitting servo light at a lower end of the pan unit 120.

The embodiment of the invention may be changed or modified in various ways as necessary, as far as such changes and modifications do not depart from the scope of the present invention hereinafter defined.

In the embodiment, both of the support shaft 111 and the support shaft 125 are borne at one position. Alternatively, it is possible to bear either one of the support shaft 111 and the support shaft 125 at one position. For instance, the pan unit 120 which is less likely to be affected by the gravitational force may be borne at two positions for pivotal movement. In this case, for instance, two support shafts are fixedly attached to upper and lower portions of a bearing portion 112, respectively, and two bearing portions (shaft holes) for pivotally bearing the support shafts are formed in a pan unit. Further alternatively, it is possible to bear the support shaft 111 at two positions, as described referring to FIG. 7A. As described above, an arrangement of bearing either one of the support shafts 111 and 125 at one position is advantageous in stabilizing pivotal movement of the mirror 140, as compared with an arrangement of bearing both of the support shafts 111 and 125 at two positions, although the arrangement is not so advantageous as the embodiment.

What is claimed is:

1. A mirror actuator comprising:
a base block;
a first pivot shaft fixedly attached to the base block;
a first pivot portion pivotally supported on the first pivot shaft;
a second pivot shaft fixedly attached to the first pivot portion and perpendicularly intersecting with the first pivot shaft;
a second pivot portion pivotally supported on the second pivot shaft; and
a mirror attached to the second pivot portion, wherein
the first pivot portion and the second pivot portion respectively have a first bearing portion and a second bearing portion for bearing the first pivot shaft and the second pivot shaft at one position.

2. The mirror actuator according to claim 1, further comprising:
a magnet portion provided on the base block;
a first coil disposed in the first pivot portion and for receiving a magnetic field from the magnet portion; and
a second coil disposed in the second pivot portion and for receiving a magnetic field from the magnet portion, wherein
the first pivot portion and the second pivot portion are pivotally moved about an axis of the first pivot shaft and an axis of the second pivot shaft, respectively, in response to application of a current to the first coil and the second coil.

3. The mirror actuator according to claim 2, further comprising:
a first conductive spring member disposed between the first pivot portion and the base block, and for supplying a current to the first coil; and
a second conductive spring member disposed between the second pivot portion and the base block, and for supplying a current to the second coil.

4. The mirror actuator according to claim 2, wherein
the magnet portion includes a magnet facing the second coil in a direction perpendicular to the second pivot shaft, and
the magnet has a surface facing the second coil, the surface being tilted with such an inclination as to decrease a variation of the magnetic field to be applied to the second coil, when the second pivot portion is pivotally moved about the axis of the second pivot shaft.

5. The mirror actuator according to claim 1, further comprising:
a balancer for stabilizing a pivotal movement of the mirror about an axis of the first pivot shaft.

6. A beam irradiation device comprising:
a mirror actuator; and
a laser light source,
the mirror actuator including:
a base block;
a first pivot shaft fixedly attached to the base block;
a first pivot portion pivotally supported on the first pivot shaft;
a second pivot shaft fixedly attached to the first pivot portion and perpendicularly intersecting with the first pivot shaft;
a second pivot portion pivotally supported on the second pivot shaft; and
a mirror attached to the second pivot portion, wherein
the first pivot portion and the second pivot portion respectively have a first bearing portion and a second bearing portion for bearing the first pivot shaft and the second pivot shaft at one position, and
the laser light source supplies laser light to the mirror of the mirror actuator.

7. The beam irradiation device according to claim 6, further comprising:
a magnet portion provided on the base block;
a first coil disposed in the first pivot portion and for receiving a magnetic field from the magnet portion; and
a second coil disposed in the second pivot portion and for receiving a magnetic field from the magnet portion, wherein
the first pivot portion and the second pivot portion are pivotally moved about an axis of the first pivot shaft and an axis of the second pivot shaft, respectively, in response to application of a current to the first coil and the second coil.

8. The beam irradiation device according to claim 7, further comprising:
a first conductive spring member disposed between the first pivot portion and the base block, and for supplying a current to the first coil; and
a second conductive spring member disposed between the second pivot portion and the base block, and for supplying a current to the second coil.

9. The beam irradiation device according to claim 7, wherein
the magnet portion includes a magnet facing the second coil in a direction perpendicular to the second pivot shaft, and
the magnet has a surface facing the second coil, the surface being tilted with such an inclination as to decrease a variation of the magnetic field to be applied to the second coil, when the second pivot portion is pivotally moved about the axis of the second pivot shaft.

10. The beam irradiation device according to claim 6, further comprising:
a balancer for stabilizing a pivotal movement of the mirror about an axis of the first pivot shaft.
